(19) United States
(12) Patent Application Publication
(10) Pub. No.: US 2026/0162881 A1
(43) Pub. Date: Jun. 11, 2026

(54) COIL DEVICE

(71) Applicant: TDK CORPORATION, Tokyo (JP)

(72) Inventors: Satoshi SUGIMOTO, Tokyo (JP); Tomoya Ishihara, Tokyo (JP); Kosuke Endo, Tokyo (JP)

(73) Assignee: TDK CORPORATION, Tokyo (JP)

(21) Appl. No.: 19/277,955

(22) Filed: Jul. 23, 2025

(30) Foreign Application Priority Data
Jul. 26, 2024 (JP) 2024-121386

(51) Int. Cl. H01F 27/30; H01F 27/255

(52) U.S. Cl. CPC H01F 27/306; H01F 27/255

(57) ABSTRACT

A coil device includes a core; a first conductor including a first coil portion inside the core, a first mounting portion partly exposed from the core, and a first connecting portion connecting the first coil portion and the first mounting portion; and a second conductor including a second coil portion extending along the first coil portion, a second mounting portion partly exposed from the core, and a second connecting portion connecting the second coil portion and the second mounting portion. At least either the first or second connecting portion becomes distant from the winding direction to provide an inter-conductor space therebetween with a distance increasing between the first and second conductors toward a mounting object. The space has a coupling controlling member including at least either a non-magnetic portion including a resin or a magnetic portion including a magnetic material.

### TECHNICAL FIELD

The present invention relates to a coil device used as an inductor or the like for uses involving low voltages and large currents.

### BACKGROUND

Demand for a coil device for uses involving low voltages and large currents, such as uses in a TLVR circuit, is increasing. Suggested as a coil device for uses involving low voltages and large currents is, for example, a coil device shown in Patent Document 1. However, in a conventional coil device, it is unfortunately difficult to control a coupling coefficient between a first conductor and a second conductor inside a core. In a situation where, for example, positioning accuracy of the first conductor and the second conductor is low or a magnetic material unintentionally enters a space between the first conductor and the second conductor, the coupling coefficient between the first conductor and the second conductor may not be a value intended at the time of designing. This is a problem.

Patent Document 1: JP Patent Application Laid Open No. 2022-33703

### SUMMARY

The present disclosure relates to a coil device with an accurately controllable coupling coefficient between a first conductor and a second conductor.

To resolve the above issue, a coil device according to the present disclosure includes
a core including a metal powder and a resin;
a first conductor including
   a first coil portion inside the core,
   a first mounting portion at least partly exposed from the core and configured to face
   a mounting object on which the coil device is mountable, and
   a first connecting portion connecting the first coil portion and the first mounting portion; and
a second conductor including
   a second coil portion inside the core,
   a second mounting portion at least partly exposed from the core and configured to face the mounting object, and
   a second connecting portion connecting the second coil portion and the second mounting portion;
wherein
the second coil portion extends along a winding direction of the first coil portion inward from the first coil portion;
at least either the first connecting portion or the second connecting portion becomes distant from the winding direction to provide an inter-conductor space between the first conductor and the second conductor, the inter-conductor space having a distance increasing between the first conductor and the second conductor toward the mounting object; and
the inter-conductor space has a coupling controlling member disposed therein, the coupling controlling member including at least either a non-magnetic portion including a resin or a magnetic portion including a magnetic material.

In such a coil device, the second coil portion of the second conductor extends along the winding direction of the first coil portion inward from the first coil portion. This can increase positioning accuracy between the first conductor and the second conductor to enable reduction of variance in a coupling coefficient between the first conductor and the second conductor. Also, between the first conductor and the second conductor is the inter-conductor space. Thus, changing the size of this inter-conductor space or the coupling controlling member disposed in the inter-conductor space can accurately control the coupling coefficient between the first conductor and the second conductor of such a coil device. Also, the inter-conductor space has a shape that widens toward the mounting object. Thus, in such a coil device, a wide control range of the coupling coefficient between the first conductor and the second conductor can be provided.

For example, the coupling controlling member may have a resin content higher than that of the core.

Increasing the resin content of the coupling controlling member to reduce the magnetic material content thereof can increase the coupling coefficient between the first conductor and the second conductor.

For example, the coupling controlling member may include the magnetic portion including the magnetic material.

Inclusion of the magnetic portion in the coupling controlling member can provide a wide control range of the coupling coefficient between the first conductor and the second conductor.

For example, the magnetic material included in the magnetic portion may be in a form of a metal powder; and a content ratio of the metal powder included in the magnetic portion to a resin included therein may be substantially the same as that of the core.

In such a coil device, the same material as that of the core being disposed in the inter-conductor space can constitute the coupling controlling member. Thus, manufacture of the coil device is easy, and variance in the coupling coefficient from a designed value can be more suitably prevented.

For example, the magnetic portion may have a higher permeability than that of the core.

Disposition of the material having a high permeability as the coupling controlling member can further reduce the coupling coefficient between the first conductor and the second conductor to provide a wide control range of the coupling coefficient between the first conductor and the second conductor.

For example, the first connecting portion may be bent; the first mounting portion connected to the first connecting portion may extend away from a device central axis with respect to the first connecting portion leading to the first coil portion; the second connecting portion may be bent; and the second mounting portion connected to the second connecting portion may extend toward the device central axis with respect to the second connecting portion leading to the second coil portion.

In such a coil device, because the first connecting portion and the second connecting portion are bent in opposite directions, the inter-conductor space can be widely provided. In such a coil device, a wide control range of the coupling coefficient between the first conductor and the second conductor can be provided.

For example, the first mounting portion may include a first mounting surface configured to face the mounting object; the second mounting portion may include a second mounting surface configured to face the mounting object; and a connection location between the first connecting portion and the first coil portion may be more distant from a plane containing the first mounting surface and the second mounting surface than a connection location between the second connecting portion and the second coil portion is.

Locating the connection location between the first coil portion and the first connecting portion, which are disposed outward, higher than the connection location between the second coil portion and the second connecting portion, which are disposed inward, can holistically reduce curvature of a curved portion (e.g., the first connecting portion) included in the first conductor to reduce variance in shape, accompanying bending, of the first conductor.

For example, the first connecting portion may be in a straight line to straightly connect the first coil portion and the first mounting portion; the second connecting portion may be bent; and the second mounting portion connected to the second connecting portion may extend toward the device central axis with respect to the second connecting portion leading to the second coil portion.

The first connecting portion of the first conductor disposed outward being in the straight line can holistically reduce curvature of the curved portion included in the first conductor to reduce variance in shape of the first conductor.

For example, the first coil portion may have a sectional area larger than that of the second coil portion in a section orthogonal to the winding direction.

In such a coil device, because the first coil portion having a larger sectional area is disposed outward from the second coil portion, curvature of the curved portion included in the first conductor can be holistically reduced to reduce variance in shape of the first conductor.

For example, the first mounting portion may include the first mounting surface and a first mounting portion upper surface, the first mounting surface being configured to face the mounting object, the first mounting portion upper surface being opposite the first mounting surface; the second mounting portion may include the second mounting surface and a second mounting portion upper surface, the second mounting surface being configured to face the mounting object, the second mounting portion upper surface being opposite the second mounting surface; and at least either the first mounting portion upper surface or the second mounting portion upper surface may be more distant from a plane containing the first mounting surface and the second mounting surface than a core lower surface of the core is.

In such a coil device, locating the core lower surface of the core at a lower height can increase self-inductance and reduce leakage of a magnetic flux to the outside.

For example, the coupling controlling member may be disposed inside the core.

In such a coil device, increasing the magnetic flux that passes through the coupling controlling member can further reduce the coupling coefficient between the first conductor and the second conductor to provide a wide control range of the coupling coefficient between the first conductor and the second conductor.

For example, an inner surface of the first coil portion and an outer surface of the second coil portion may be coupled to each other using an adhesive hardened portion including a hardened adhesive; and the adhesive hardened portion may extend along the winding direction and have an end leading to the coupling controlling member.

In such a coil device, misalignment or the like of the first conductor and the second conductor during manufacture can be prevented, and the resin content of the coupling controlling member can be accurately controlled. Thus, the coupling coefficient between the first conductor and the second conductor can be more accurately controlled.

### BRIEF DESCRIPTION OF THE DRAWING(S)

FIG. 1 is a perspective view of a coil device according to one embodiment of the present disclosure viewed diagonally from below.

FIG. 2 is a perspective view of the coil device shown in FIG. 1 viewed diagonally from above.

FIG. 3 is a bottom plan view of a core of the coil device shown in FIG. 1.

FIG. 4 is a first sectional view of the coil device shown in FIG. 1.

FIG. 5 is a second sectional view of the coil device shown in FIG. 1.

FIG. 6 is a perspective view of a first conductor, a second conductor, an adhesive hardened portion, and a coupling controlling member of the coil device shown in FIG. 1.

FIG. 7 is a schematic view of the first conductor, the adhesive hardened portion, and the coupling controlling member of the coil device shown in FIG. 1.

FIG. 8 is a schematic view of the second conductor of the coil device shown in FIG. 1.

FIG. 9 is a schematic view of an arrangement relationship between the core and inter-conductor spaces of the coil device shown in FIG. 1.

FIG. 10 is a schematic view of an arrangement relationship between a core and inter-conductor spaces of a coil device according to a first modified example.

FIG. 11 is a schematic view of an arrangement relationship between a core and inter-conductor spaces of a coil device according to a second modified example.

FIG. 12 is a schematic view of a coil device according to a second embodiment.

FIG. 13 is a schematic view of a first conductor, a second conductor, an adhesive hardened portion, and a coupling controlling member included in the coil device shown in FIG. 12.

FIG. 14 is a schematic view of a coil device according to a third embodiment.

FIG. 15 is a schematic view of a first conductor, a second conductor, and a coupling controlling member included in the coil device shown in FIG. 14.

FIGS. 16A to 16C are schematic views of coil devices according to examples.

### DETAILED DESCRIPTION

Hereinafter, embodiments are described.

### First Embodiment

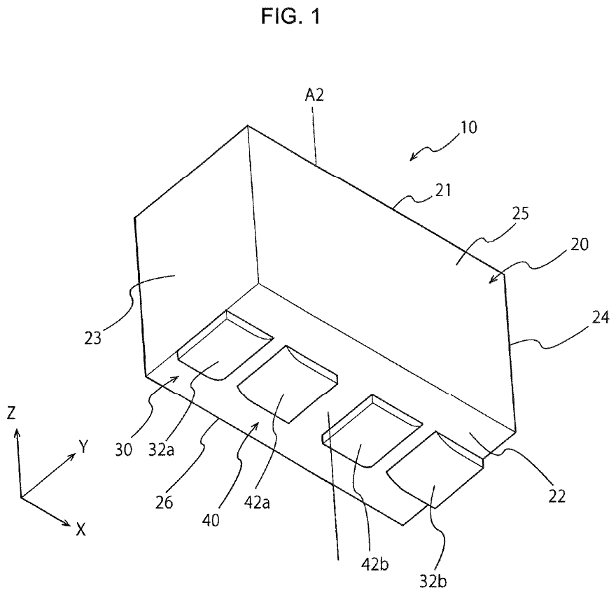

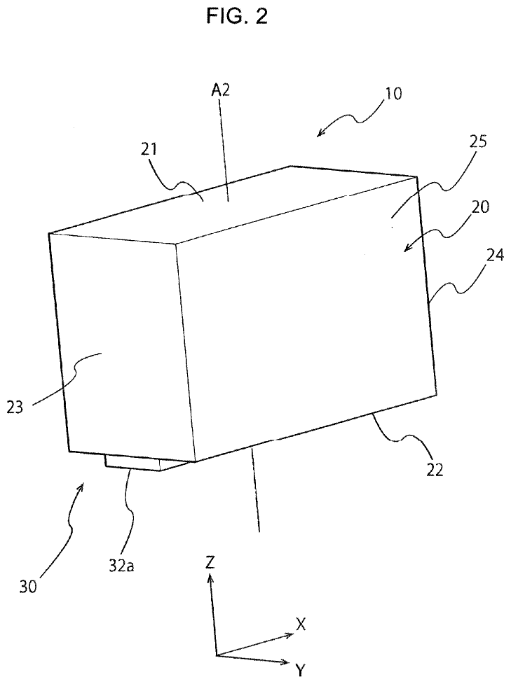

As shown in FIGS. 1 and 2, a coil device 10 according to the embodiment has a substantially rectangular parallelepiped shape and is used as a coil device for uses involving low voltages and large currents, such as uses in a TLVR circuit. The coil device 10 has, for example, a length of 3.0 to 12.0 mm in the X-axis direction, a width of 3.0 to 6.0 mm in the Y-axis direction, and a height of 3.0 to 12.0 mm in the Z-axis direction. In the figures, the X-axis, the Y-axis, and the Z-axis are substantially perpendicular to each other. In the present embodiment, the Z-axis corresponds to the height orientation of the coil device 10. In the following description, a direction toward a center of a member (e.g., a center of the coil device 10) along each axis is defined as an inward direction whereas a direction away from the center along each axis is defined as an outward direction.

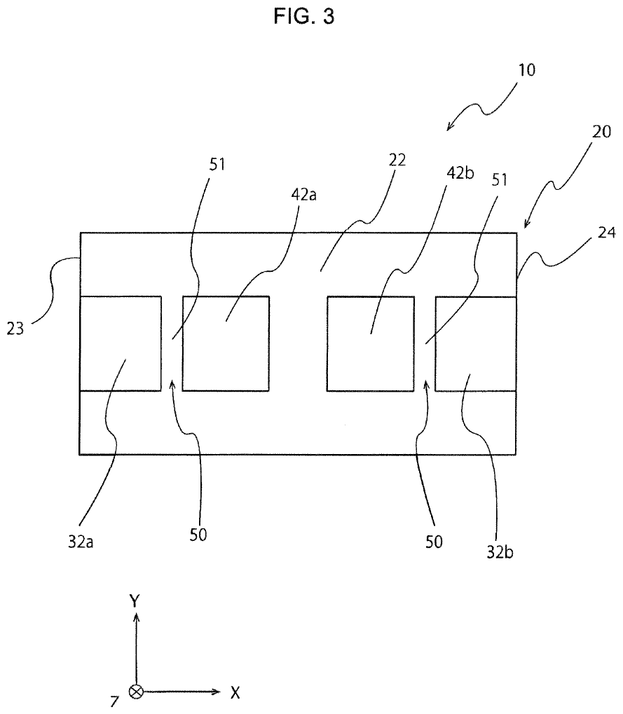

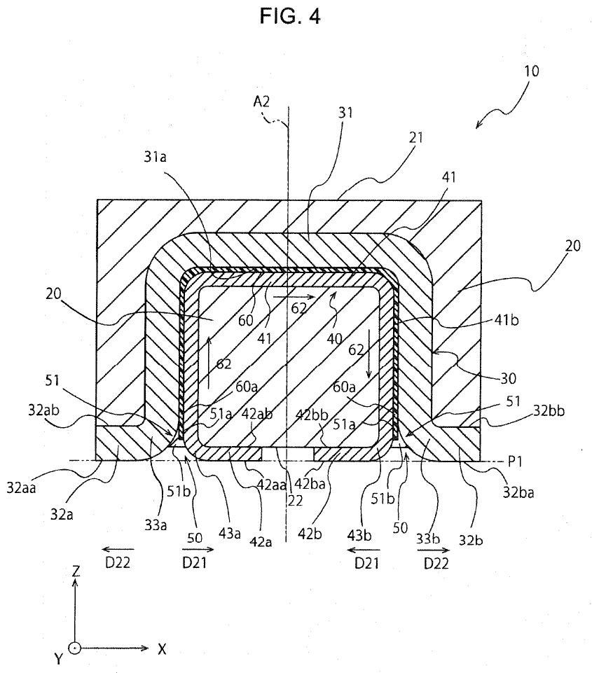

As shown in FIGS. 1 to 3, the coil device 10 includes a core 20 including a metal powder and a resin; a first conductor 30; and a second conductor 40. The first conductor 30 includes two first mounting portions 32a, 32b at least partly exposed from the core 20. The second conductor 40 includes two second mounting portions 42a, 42b at least partly exposed from the core 20. In the coil device 10, the first conductor 30, which is disposed relatively outward, functions as a primary coil, and the second conductor 40, which is disposed relatively inward, functions as a secondary coil. However, which of the first conductor 30 and the second conductor 40 is to be the primary coil or the secondary coil may be appropriately changed according to, for example, a use of the coil device 10. An inner coil may be the primary coil, and an outer coil may be the secondary coil. Details of the first conductor 30 and the second conductor 40 are provided later with reference to FIGS. 4 to 7.

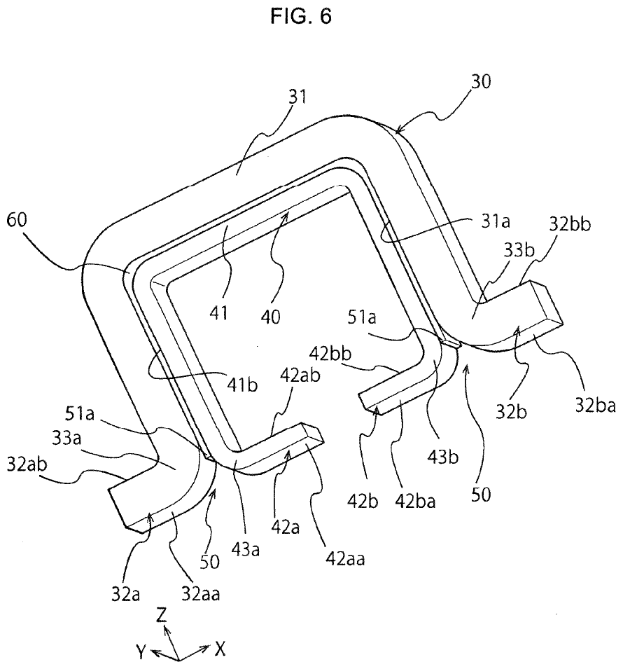

The core 20 is obtained using, for example, compression molding of a material powder, in which the metal powder and the resin are mixed, with a mold having the first conductor 30 and the second conductor 40 shown in FIG. 6 disposed inside. Examples of the metal powder include an Fe—Ni alloy powder, an Fe—Si alloy powder, an Fe—Si—Cr alloy powder, an Fe—Co alloy powder, an Fe—Si—Al alloy powder, and amorphous iron. The metal powder is not limited. Examples of the resin included in the core 20 include an epoxy resin, a phenol resin, a polyester resin, a polyurethane resin, a polyimide resin, and other synthetic resin. The resin is not limited.

As shown in FIGS. 1 to 3, the core 20 has a substantially rectangular parallelepiped external shape. Outer surfaces of the core 20 include a core upper surface 21, a core lower surface 22, a first outer surface 23, a second outer surface 24, a third outer surface 25, and a fourth outer surface 26. As shown in FIG. 1, from the core lower surface 22, which faces downward, the first mounting portions 32a, 32b (part of the first conductor 30), the second mounting portions 42a, 42b (part of the second conductor 40), and the like are exposed. Among the outer surfaces of the core 20 of the coil device 10, the core upper surface 21, the first outer surface 23, the second outer surface 24, the third outer surface 25, and the fourth outer surface 26 are flat surfaces, except the core lower surface 22. However, the surfaces other than the core lower surface 22 may also have irregularities or the like or may have a protrusion or the like.

FIG. 4 is a first sectional view of the coil device 10 shown in FIG. 1. In the first sectional view, the coil device 10 is observed in a section that contains a device central axis A2, which passes through the center of the coil device 10 and is parallel to the height orientation (Z-axis), and is parallel to the X-axis. As shown in FIG. 4, the first conductor 30 includes a first coil portion 31 inside the core 20; the first mounting portions 32a, 32b at least partly exposed from the core 20 and configured to face a mounting object on which the coil device is mountable; and two first connecting portions 33a, 33b connecting the first coil portion 31 and the first mounting portions 32a, 32b.

FIG. 6 is a schematic perspective view of the first conductor 30, the second conductor 40, and the like included in the coil device 10 shown in FIGS. 1 to 3. As shown in FIGS. 6 and 4, an inner surface 31a of the first coil portion 31 and an outer surface 41b of a second coil portion 41 of the second conductor 40 face each other and are coupled to each other using an adhesive hardened portion 60, which includes a hardened adhesive.

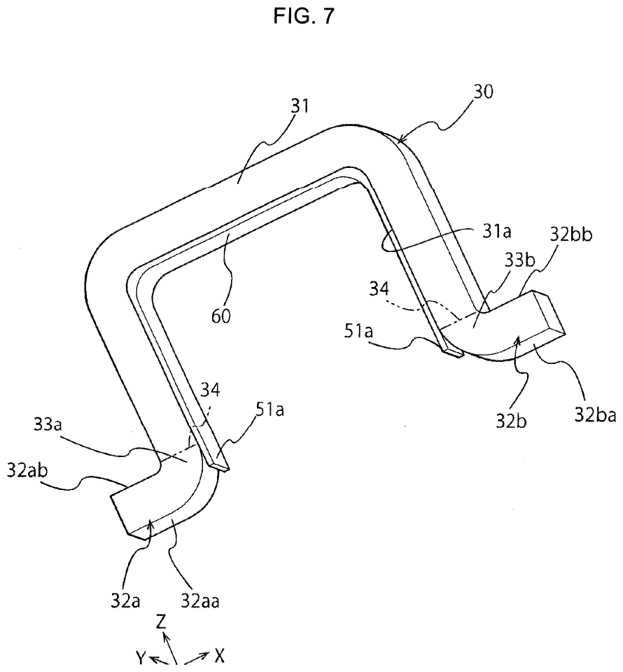

FIG. 7 is a schematic perspective view of the first conductor 30, the adhesive hardened portion 60, and the like included in the coil device 10. As shown in FIGS. 4, 6, and 7, the first conductor 30 has a rectangular wave shape protruding upward viewed from the Y-axis direction. The first conductor 30 can be manufactured by, for example, machining a metal bar or a rectangular wire. Methods of manufacturing the first conductor 30 are not limited. Examples of a material of the first conductor 30 include good conductor metals, such as copper, iron, gold, silver, aluminum, and their alloys. The material is not limited as long as it functions as a current path of the coil device 10.

Although not shown in FIG. 4 or FIG. 6, surfaces of the first conductor 30 may be provided with insulating films of a resin or the like. At a portion where the first conductor 30 and the second conductor 40 adhere to each other shown in FIG. 6, the insulating films on the surfaces of the first conductor 30 or the second conductor 40 (in a situation where the adhesive hardened portion 60 is not used) or the insulating films and the adhesive hardened portion 60 (in a situation where the insulating adhesive hardened portion 60 is used) provide electrical insulation. Note that the insulating films of the first conductor 30 are not provided at first mounting surfaces 32aa, 32ba, which are lower surfaces of the first mounting portions 32a, 32b.

As shown in FIGS. 4 and 6, the two first mounting portions 32a, 32b included in the first conductor 30 are disposed at one end and an other end of the first conductor 30 in the X-axis direction. The one first coil portion 31 included in the first conductor 30 is disposed at a central portion of the first conductor 30 in the X-axis direction.

The first coil portion 31 has a U-shaped external shape opening downward viewed from the Y-axis direction. A central portion of the coil device 10 is surrounded by the first coil portion 31 from three sides, which are the top and both sides in the X-axis direction.

The first mounting portion 32a, which constitutes an end of the first conductor 30 in the negative direction of the X-axis, is connected to a lower (in the negative direction of the Z-axis) end of the first coil portion 31 in the negative direction of the X-axis, with the first connecting portion 33a therebetween. The first connecting portion 33a is bent; and the first mounting portion 32a, to which the first connecting portion 33a is connected, extends in a device outward direction D22 (away from the device central axis A2) with respect to the first connecting portion 33a, which leads to the first coil portion 31.

By contrast, the first mounting portion 32b, which constitutes an end of the first conductor 30 in the positive direction of the X-axis, is connected to a lower (in the negative direction of the Z-axis) end of the first coil portion 31 in the positive direction of the X-axis, with the first connecting portion 33b therebetween. The first connecting portion 33b is bent; and the first mounting portion 32b, to which the first connecting portion 33b is connected, extends in the device outward direction D22 with respect to the first connecting portion 33b, which leads to the first coil portion 31. Note that the first conductor 30 is symmetrical with respect to the device central axis A2.

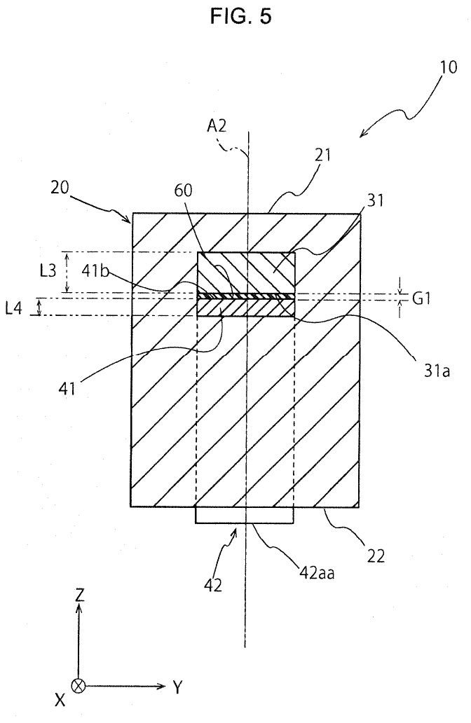

FIG. 5 is a second sectional view of the coil device 10 shown in FIG. 1. In the second sectional view, the coil device 10 is observed in a section that contains the device central axis A2, which passes through the center of the coil device 10 and is parallel to the height orientation (Z-axis), and is parallel to the Y-axis. As shown in FIG. 5, the inner surface 31a of the first coil portion 31 and the outer surface 41b of the second coil portion 41 of the second conductor 40 are fixed to each other using the adhesive hardened portion 60, which is thinner than the first coil portion 31 and the second coil portion 41. Resin or the like constitutes the adhesive hardened portion 60.

A gap G1, provided by the adhesive hardened portion 60, between the inner surface 31a of the first coil portion 31 and the outer surface 41b of the second coil portion 41 is substantially constant along a winding direction 62 of the first coil portion 31 and the second coil portion 41, as shown in FIG. 4. The gap G1 between the inner surface 31a of the first coil portion 31 and the outer surface 41b of the second coil portion 41 has an average thickness that is preferably, for example, about 1/16 to about ¼ of the average thickness of the first coil portion 31, in terms of ensuring the fixing strength between the first conductor 30 and the second conductor 40 and preventing entry of the metal powder or the like to the gap between the first conductor 30 and the second conductor 40.

Note that, between the inner surface 31a of the first coil portion 31 and the outer surface 41b of the second coil portion 41 may be a resin-made spacer or the like instead of the adhesive hardened portion 60 or in combination with the adhesive hardened portion 60.

As can be understood from comparison between FIGS. 1 and 6, lower halves of the first mounting portions 32a, 32b and part of the first connecting portions 33a, 33b are exposed below from the core lower surface 22 of the core 20. Note that, with not only the first mounting surfaces 32aa, 32ba (the lower surfaces of the first mounting portions 32a, 32b) but also part of a side surface of the first mounting portion 32a or part of the first connecting portions 33a, 33b being exposed below from the core lower surface 22 of the core 20, formation of a solder fillet at the time of mounting becomes easy to enable the coil device to be firmly mounted.

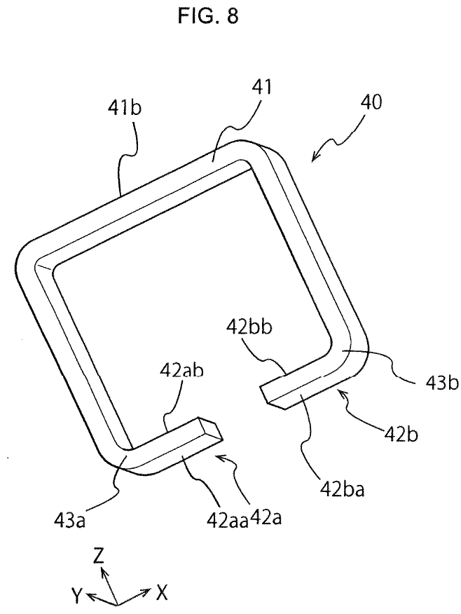

FIG. 8 is a schematic perspective view of the appearance shape of the second conductor 40 included in the coil device 10. As shown in FIGS. 4 and 8, the second conductor 40 includes the second coil portion 41 inside the core 20; the second mounting portions 42a, 42b at least partly exposed from the core 20 and configured to face the mounting object; and two second connecting portions 43a, 43b connecting the second coil portion 41 and the second mounting portions 42a, 42b.

As shown in FIG. 4, the second coil portion 41 of the second conductor 40 extends along the winding direction 62 and inward from the first coil portion 31 while adhering to the first coil portion 31 with the adhesive hardened portion 60 therebetween. As shown in FIGS. 4 and 8, the second conductor 40 has a rectangular ring shape (C ring shape) having a lower gap viewed from the Y-axis direction. A material of the second conductor 40 and a method of manufacturing the same are similar to those of the first conductor 30. The second conductor 40 and the first conductor 30 may be made from the same material or different materials.

Although not shown in FIG. 4 or FIG. 8, surfaces of the second conductor 40 may be provided with insulating films of a resin or the like. Note that, similarly to the first conductor 30, the insulating films of the second conductor 40 are not provided at second mounting surfaces 42aa, 42ba, which are lower surfaces of the second mounting portions 42a, 42b.

As shown in FIG. 4, the two second mounting portions 42a, 42b included in the second conductor 40 constitute lower portions (ends in the negative direction of the Z-axis) of the second conductor 40. The second mounting portions 42a, 42b oppose each other with the gap of the second conductor 40 therebetween. The one second coil portion 41 included in the second conductor 40 constitutes a portion upward (in the positive direction of the Z-axis) from the second mounting portions 42a, 42b and the second connecting portions 43a, 43b of the second conductor 40.

Similarly to the first coil portion 31, the second coil portion 41 has a U-shaped external shape opening downward viewed from the Y-axis direction and surrounds the central portion of the coil device 10 from the three sides, which are the top and both sides in the X-axis direction. As shown in FIGS. 4 and 6, the first coil portion 31 and the second coil portion 41 provide a double structure along the winding direction 62. The central portion of the coil device 10 is doubly surrounded by the first coil portion 31 and the second coil portion 41 from the three sides, which are the top and both sides in the X-axis direction.

The second mounting portion 42a, which is disposed in the negative direction of the X-axis from the device central axis A2, is connected to a lower (in the negative direction of the Z-axis) end of the second coil portion 41 in the negative direction of the X-axis, with the second connecting portion 43a therebetween. The second connecting portion 43a is bent; and the second mounting portion 42a, to which the second connecting portion 43a is connected, extends in a device center-side direction D21 (toward the device central axis A2) with respect to the second connecting portion 43a, which leads to the second coil portion 41.

By contrast, the second mounting portion 42b, which is disposed in the positive direction of the X-axis from the device central axis A2, of the second conductor 40 is connected to a lower (in the negative direction of the Z-axis) end of the second coil portion 41 in the positive direction of the X-axis, with the second connecting portion 43b therebetween. The second connecting portion 43b is bent; and the second mounting portion 42b, to which the second connecting portion 43b is connected, extends in the device center-side direction D21 with respect to the second connecting portion 43b, which leads to the second coil portion 41. Note that the second conductor 40 is symmetrical with respect to the device central axis A2.

As shown in FIG. 5, in a section (e.g., FIG. 5) orthogonal to the winding direction 62, the second coil portion 41 of the coil device 10 has a thickness L4 thinner than a thickness L3, where L4 is the length of the second coil portion 41 from outside inward in the coil device 10, and L3 is such a length of the first coil portion 31.

The coil device 10 has a rectangular shape in a section (e.g., FIG. 5) orthogonal to the winding direction 62 of the first coil portion 31 and the second coil portion 41. The first coil portion 31 has a sectional area larger than that of the second coil portion 41 in the section orthogonal to the winding direction 62.

As shown in FIG. 5, in a section orthogonal to the winding direction 62, the first coil portion 31 and the second coil portion 41 are substantially symmetrical with respect to a common axis of symmetry (in FIG. 5, the device central axis A2). In such a coil device 10, the first coil portion 31 and the second coil portion 41 are disposed substantially symmetrically. Thus, a characteristic variation within an acceptable manufacturing variation can be reduced.

As shown in FIG. 4, in the coil device 10, between inner surfaces of the first connecting portions 33a, 33b and an outer surface of the second conductor 40 are inter-conductor spaces 50, 50. Each of the inter-conductor spaces 50, 50 is, in FIG. 4, a substantially triangular portion, where at least either the first connecting portion 33a, 33b or the second connecting portion 43a, 43b becomes distant from the winding direction 62 to increase the distance between the first conductor 30 and the second conductor 40 toward the lower mounting object side.

In each inter-conductor space 50, a coupling controlling member 51 including at least either a non-magnetic portion 51a containing a resin or a magnetic portion 51b containing a magnetic material is disposed. Note that a hollow portion in which the coupling controlling member 51 is not disposed is not included in the inter-conductor space 50.

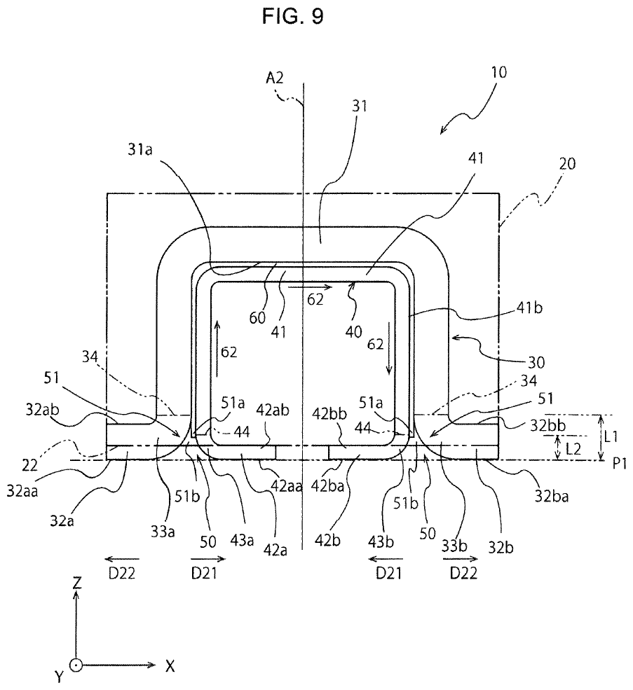

FIG. 9 is a schematic view of an arrangement relationship between the core 20 and the inter-conductor spaces 50 of the coil device 10. As can be understood from FIGS. 4 and 9, a lower end of the coupling controlling member 51 corresponds to the core lower surface 22 of the core 20 or is apart from a mounting surface P1 more than the core lower surface 22 of the core 20 is apart from the mounting surface P1, and the coupling controlling member 51 is disposed inside the core 20.

In the coil device 10, first mounting portion upper surfaces 32ab, 32bb, which are surfaces of the first mounting portions 32a, 32b opposite the first mounting surfaces 32aa, 32ba, which are configured to face the mounting object, are more distant from the mounting surface P1 than the core lower surface 22 of the core 20 is. Also, second mounting portion upper surfaces 42ab, 42bb, which are surfaces of the second mounting portions 42a, 42b opposite the second mounting surfaces 42aa, 42ba, which are configured to face the mounting object, may be more distant from the mounting surface P1 than the core lower surface 22 of the core 20 is.

Locating the core lower surface 22 of the core 20 lower than at least either the first mounting portion upper surfaces 32ab, 32bb or the second mounting portion upper surfaces 42ab, 42bb can make the coupling controlling member 51 at least partly be disposed inside the core 20 to provide a wide control range of a coupling coefficient between the first conductor 30 and the second conductor 40. Also, bringing the core lower surface 22 closer to the mounting surface to increase the volume of the core 20 can improve self-inductance or the like of the conductors 30, 40 of the coil device 10.

As shown in FIG. 9, connection locations 34 between the first connecting portions 33a, 33b and the first coil portion 31 are more distant from the mounting surface P1 than connection locations 44 between the second connecting portions 43a, 43b and the second coil portion 41 are. That is, a distance L1 between the connection locations 34 (between the first connecting portions 33a, 33b and the first coil portion 31) and the mounting surface P1 is longer than a distance L2 between the connection locations 44 (between the second connecting portions 43a, 43b and the second coil portion 41) and the mounting surface P1.

Locating the connection locations 34 (between the first coil portion 31 and the first connecting portions 33a, 33b, which are disposed outward) higher than the connection locations 44 (between the second coil portion 41 and the second connecting portions 43a, 43b, which are disposed inward) can holistically reduce curvature of curved portions (e.g., the first connecting portions 33a, 33b) included in the first conductor 30 to reduce variance in shape of the first conductor 30. Note that the mounting surface P1 is a flat surface containing the first mounting surfaces 32aa, 32ba (configured to face the mounting object) of the first mounting portions 32a, 32b and the second mounting surfaces 42aa, 42ba (configured to face the mounting object) of the second mounting portions 42a, 42b.

As shown in FIG. 9, in the coil device 10, upper ends of the inter-conductor spaces 50 start from the same height as that of the connection locations 34 between the first coil portion 31 and the first connecting portions 33a, 33b. Downwardly from the connection locations 34, the inner surfaces of the first connecting portions 33a, 33b become distant from the winding direction 62 (parallel to the Z-axis direction). Thus, the distance between the first conductor 30 and the second conductor 40 increases in the device outward direction D22, below the connection locations 34. Further, outer surfaces of the second connecting portions 43a, 43b become distant from the winding direction 62 (parallel to the Z-axis direction) below the connection locations 44 between the second coil portion 41 and the second connecting portions 43a, 43b. Thus, the distance between the first conductor 30 and the second conductor 40 increases also in the device center-side direction D21, below the connection locations 44.

As shown in FIGS. 4 and 9, the coupling controlling member 51 disposed in each inter-conductor space 50 includes the non-magnetic portion 51a containing the resin. The non-magnetic portion 51a, which partly constitutes the coupling controlling member 51, is connected to the adhesive hardened portion 60, which is disposed between the inner surface 31a of the first coil portion 31 and the outer surface 41b of the second coil portion 41. That is, the adhesive hardened portion 60 extends along the winding direction 62, and each end 60a of the adhesive hardened portion 60 is connected to the non-magnetic portion 51a of the coupling controlling member 51. Also, the adhesive hardened portion 60 and the non-magnetic portion 51a are of the same material.

The non-magnetic portion 51a preferably does not include a magnetic material in terms of controlling the coupling coefficient between the first conductor 30 and the second conductor 40 using, for example, the volume ratio of the non-magnetic portion 51a to the magnetic portion 51b. However, the non-magnetic portion 51a may include a magnetic material (e.g., a magnetic powder) at a content sufficiently lower than that of the magnetic portion 51b or the core 20.

As shown in FIGS. 4 and 9, the coupling controlling member 51 disposed in each inter-conductor space 50 includes the magnetic portion 51b containing the magnetic material. In the coil device 10, the non-magnetic portion 51a containing the resin is disposed in a region near the upper end of the inter-conductor space 50, and the magnetic portion 51b containing the magnetic material is disposed in a region near a lower end of the inter-conductor space 50.

In the coil device 10, the material of the magnetic portion 51b is the same as the material of the core 20. That is, the magnetic material included in the magnetic portion 51b is the metal powder, and the content ratio of the metal powder included in the magnetic portion 51b to the resin included therein is substantially the same as that of the core 20. In the coil device 10 including the core 20 and the magnetic portion 51b made from the same material, for example, controlling the height of the core lower surface 22 shown in FIGS. 4 and 9 can easily control the shapes of the magnetic portion 51b and the inter-conductor spaces 50. Thus, manufacture of the coil device is easy, and the coupling coefficient between the first conductor 30 and the second conductor 40 can be accurately controlled.

In the coil device 10, the coupling controlling member 51 includes not only the magnetic portion 51b, which is made from the same material as that of the core 20, but also the non-magnetic portion 51a. Thus, the resin content of the coupling controlling member 51 as a whole is higher than the resin content of the core 20. Increasing the resin content of the coupling controlling member 51 to reduce the magnetic material content thereof can increase the coupling coefficient between the first conductor 30 and the second conductor 40.

Unlike the coil device 10 shown in FIGS. 4 and 9, the material of the magnetic portion 51b included in the coupling controlling member 51 may be different from the material of the core 20 to make the magnetic portion 51b have a higher permeability than that of the core 20. Increasing the permeability of the magnetic portion 51b can greatly fluctuate the coupling coefficient between the first conductor 30 and the second conductor 40 using the small inter-conductor spaces 50 and the coupling controlling member 51. A higher permeability of the magnetic portion 51b or a higher volume ratio of the magnetic portion 51b in the coupling controlling member 51 can improve characteristics (e.g., self-inductance) of the conductors 30, 40 included in the coil device 10.

As shown in FIGS. 4 and 9, in the coil device 10, the second coil portion 41 of the second conductor 40 extends along the winding direction 62 of the first coil portion 31 inward from the first coil portion 31. This can increase positioning accuracy between the first conductor 30 and the second conductor 40 to enable reduction of variance in the coupling coefficient between the first conductor 30 and the second conductor 40. Also, between the first conductor 30 and the second conductor 40 are the inter-conductor spaces 50. Thus, changing the sizes of these inter-conductor spaces 50 or the coupling controlling member 51 disposed in the inter-conductor spaces 50 can accurately control the coupling coefficient between the first conductor 30 and the second conductor 40 of such a coil device. Also, the inter-conductor spaces 50 have shapes that widen toward the mounting object. Thus, in the coil device 10, a wide control range of the coupling coefficient between the first conductor 30 and the second conductor 40 can be provided. Also, coil devices 10 having approximately similar external shapes but having various coupling coefficients can be manufactured by changing only the inter-conductor spaces 50 and the coupling controlling member 51. Thus, design changes or the like can be flexibly handled.

In the coil device 10, the coupling controlling member 51 disposed in the inter-conductor spaces 50 includes both the non-magnetic portion 51a and the magnetic portion 51b. Thus, controlling the volume ratio of the non-magnetic portion 51a to the magnetic portion 51b or their materials can flexibly and accurately control the coupling coefficient between the first conductor 30 and the second conductor 40. However, unlike the above, it may be that the coupling controlling member 51 includes only the non-magnetic portion 51a. In such a coil device 10, entry of the magnetic material or the like of the core 20 into the inter-conductor spaces 50 is appropriately prevented to increase the coupling coefficient between the first conductor 30 and the second conductor 40 and reduce variance in the coupling coefficient.

Alternatively, it may be that the coupling controlling member 51 includes only the magnetic portion 51b. In such a coil device, the coupling coefficient between the first conductor 30 and the second conductor 40 can be accurately reduced.

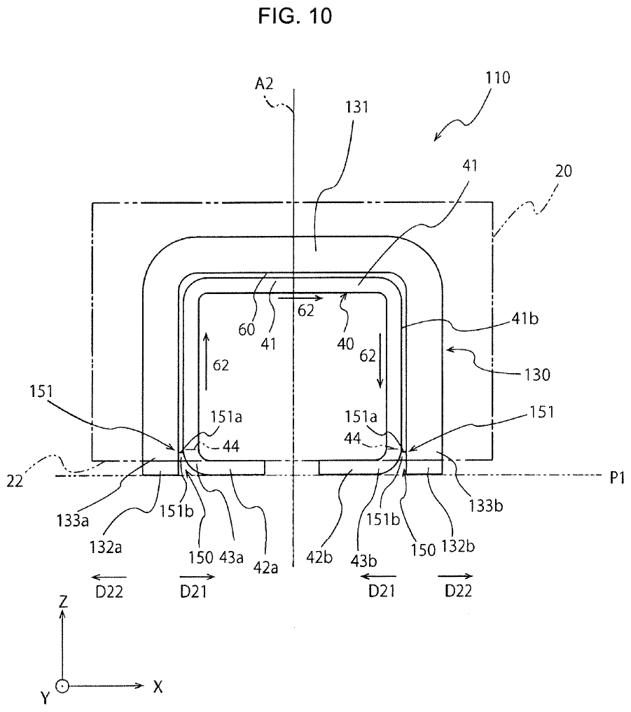

Hereinabove, the coil device according to the present disclosure has been described with reference to the embodiment. However, the technical scope of the coil device according to the present disclosure is not limited to the above embodiment and, needless to say, includes many other embodiments, modifies examples, etc. For example, FIG. 10 is a schematic view of an arrangement relationship between a core 20 and inter-conductor spaces 150 of a coil device 110 according to a first modified example.

The coil device 110 according to the first modified example shown in FIG. 10 is different from the coil device 10 according to the first embodiment in respect to shapes of a first conductor 130, the inter-conductor spaces 150, a coupling controlling member 151, and the like but is similar to the coil device 10 according to the first embodiment in respect to the external shape of the core 20 or a second conductor 40. Description of the coil device 110 is provided focusing on the difference between the coil devices 110 and 10. Description of similarities between the coil devices 110 and 10 is omitted.

As shown in FIG. 10, in respect to the first conductor 130, the shape of a first coil portion 131 is approximately similar to the shape of the first coil portion 31 shown in FIG. 9, but shapes of first connecting portions 133a, 133b and first mounting portions 132a, 132b are different from those of the first coil portion 31. That is, in the first conductor 130, the first connecting portions 133a, 133b are in a straight line to connect the first coil portion 131 and the first mounting portions 132a, 132b straightly along a winding direction 62.

The first conductor 130 has a U-shaped external shape opening downward viewed from the Y-axis direction as a whole. One end surface and an other end surface of the first conductor 130 face downward, and the respective end surfaces constitute first mounting surfaces of the first mounting portions 132a, 132b configured to face a mounting object. The shape of the first conductor 130, in which the first connecting portions 133a, 133b are in a straight line, is preferable in a situation where a sectional area perpendicular to the winding direction 62 of the first coil portion 131 is large (e.g., the sectional area is at least twice the sectional area of a second coil portion 41). Because the first conductor 130, in which the first connecting portion 133a is in a straight line, has a simple shape, is easily manufactured, and has a large sectional area, the end surface of the first conductor 130 can provide a facing area necessary for the mounting object.

As shown in FIG. 10, in the coil device 110, upper ends of the inter-conductor spaces 150 start from the same height as that of connection locations 44 between the second coil portion 41 and second connecting portions 43a, 43b. Downwardly from the connection locations 44, outer surfaces of the second connecting portions 43a, 43b become distant from the winding direction 62 (parallel to the Z-axis direction). Thus, the distance between the first conductor 130 and the second conductor 40 increases in a device center-side direction D21, below the connection locations 44.

The coupling controlling member 151 disposed in the inter-conductor spaces 150 includes a non-magnetic portion 151a containing a resin. The non-magnetic portion 151a, which partly constitutes the coupling controlling member 151, is connected to an adhesive hardened portion 60, which is disposed between an inner surface 131a of the first coil portion 131 and an outer surface 41b of the second coil portion 41.

The coupling controlling member 151 disposed in the inter-conductor spaces 150 also includes a magnetic portion 151b containing a magnetic material. The material of the magnetic portion 151b is the same as the material of the core 20.

Similarly to the coil device 10 according to the first embodiment, in the coil device 110 shown in FIG. 10, changing the sizes of the inter-conductor spaces 150 or the coupling controlling member 151 disposed in the inter-conductor spaces 150 can accurately control the coupling coefficient between the first conductor 130 and the second conductor 40 of such a coil device. Note that, because the inter-conductor spaces 150 of the coil device 110 are smaller in size than those of the coil device 10, the controllable range of the coupling coefficient tends to be smaller than that of the coil device 10 according to the first embodiment. However, because the first connecting portions 133a, 133b of the coil device 110 extend straightly to enable reduction in variation in shape of the inter-conductor spaces 150, the coil device 110 is superior in terms of control accuracy of the coupling coefficient.

While the coil device 110 is similar to the coil device 10 according to the first embodiment in respect to the shape of the second conductor 40 and is different from the coil device 10 in respect to the shape of the first conductor 130, other coil devices in some embodiments can be similar to the coil device 10 according to the first embodiment in respect to the shape of the first conductor 30 and be different from the coil device 10 in respect to the shape of the second conductor 40. In this situation, the second conductor of the other coil devices has a U-shaped external shape opening downward viewed from the Y-axis direction as a whole. One end surface and an other end surface of the second conductor face downward, and the respective end surfaces constitute second mounting surfaces of second mounting portions configured to face a mounting object (see the shape of the first conductor 130 shown in FIG. 10). Inter-conductor spaces are provided between second connecting portions in a straight line and bent first connecting portions.

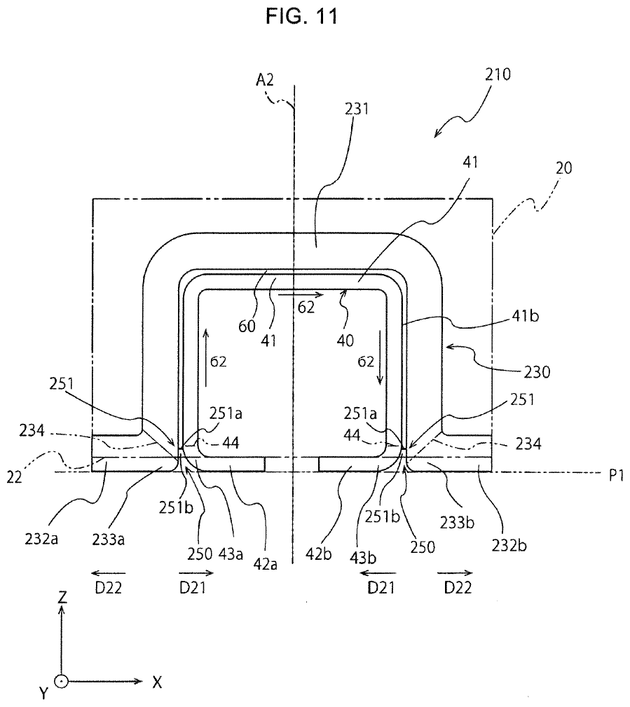

FIG. 11 is a schematic view of an arrangement relationship between a core 20 and inter-conductor spaces 250 of a coil device 210 according to a second modified example. The coil device 210 according to the second modified example shown in FIG. 11 is different from the coil device 10 according to the first embodiment in respect to shapes of a first conductor 230, the inter-conductor spaces 250, a coupling controlling member 251, and the like but is similar to the coil device 10 according to the first embodiment in respect to the external shape of the core 20 or a second conductor 40. Description of the coil device 210 is provided focusing on the difference between the coil devices 210 and 10. Description of similarities between the coil devices 210 and 10 is omitted.

As shown in FIG. 11, the first conductor 230 is different from the first conductor 30 of the first embodiment in that connection locations 234 between a first coil portion 231 and first connecting portions 233a, 233b are different between an inner surface and an outer surface of the first conductor 230. That is, the heights at which the first conductor 230 starts to bend outward to be the connection locations 234 (distance from a mounting surface P1) are different between the inner surface and the outer surface. The connection locations 234 are closer to the mounting surface P1 in the inner surface whereas the connection locations 234 are more distant from the mounting surface P1 in the outer surface. In the first conductor 230, such locations in the inner surface, which faces the second conductor 40, are adopted as the connection locations 234 between the first coil portion 231 and the first connecting portions 233a, 233b.

While the first connecting portions 33a, 33b and the first mounting portions 32a, 32b of the first conductor 30 shown in FIG. 9 are prepared by, for example, bending, the first connecting portions 233a, 233b and first mounting portions 232a, 232b of the first conductor 230 shown in FIG. 11 are prepared by, for example, raising or cutting.

As shown in FIG. 11, in the coil device 210, upper ends of the inter-conductor spaces 250 start from the same height as that of connection locations 44 between a second coil portion 41 and second connecting portions 43a, 43b. Downwardly from the connection locations 44, outer surfaces of the second connecting portions 43a, 43b become distant from a winding direction 62 (parallel to the Z-axis direction). Thus, the distance between the first conductor 230 and the second conductor 40 increases in a device center-side direction D21, below the connection locations 44. By contrast, the connection locations 234 in the inner surface of the first conductor 230 are at a lower height than that of a lower end of the coupling controlling member 251; and the shape of the inner surface of the first conductor 230 of the coil device 210 does not affect the shapes of the inter-conductor spaces 250.

The coupling controlling member 251 disposed in the inter-conductor spaces 250 includes a non-magnetic portion 251a containing a resin and a magnetic portion 251b containing a magnetic material. Characteristics of the coupling controlling member 251 are similar to those of the coupling controlling member 151 included in the coil device 110 according to the first modified example shown in FIG. 10.

Similarities between the coil device 210 according to the second modified example shown in FIG. 11 and the coil devices 10 and 110 according to the first embodiment and the first modified example bring similar effects brought by the coil devices 10 and 110.

### Second Embodiment

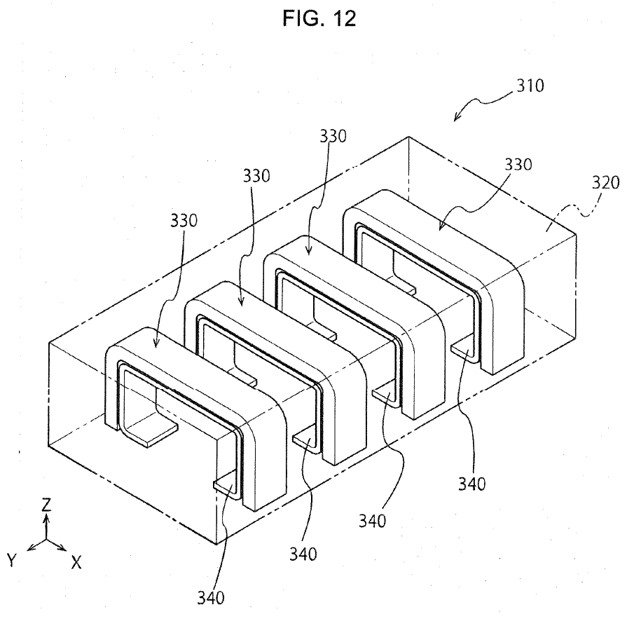

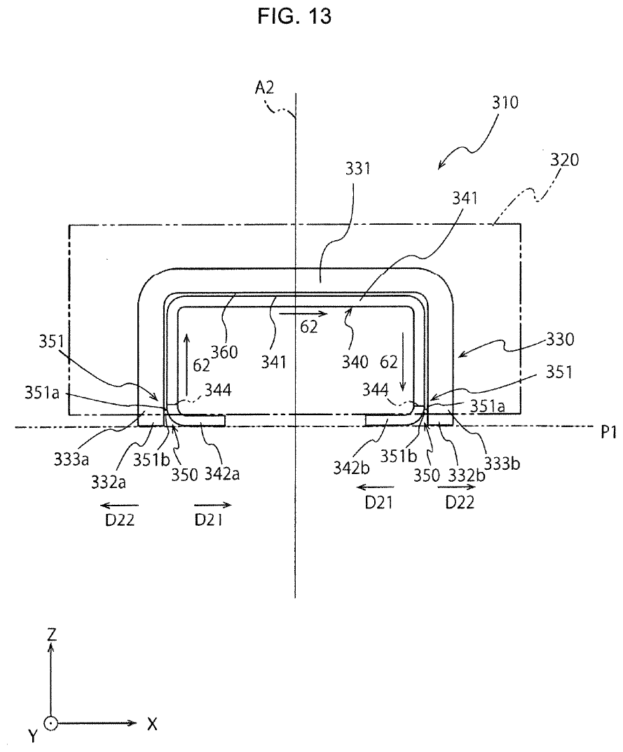

FIG. 12 is a schematic view of an overall structure of a coil device 310 according to a second embodiment. FIG. 13 is a schematic view of an arrangement relationship between a core 320 and inter-conductor spaces 350 of the coil device 310. The coil device 310 according to the second embodiment includes, inside the one core 320, four pairs of a first conductor 330 and a second conductor 340 shown in FIG. 13. The pairs of the first conductor 330 and the second conductor 340 are arranged at substantially regular intervals along the Y-axis direction of the coil device 310.

As can be understood from comparison between FIG. 10 and FIGS. 12 and 13, the coil device 310 (see FIGS. 12 and 13) is different from the coil device 110 (see FIG. 10), which includes one pair of the first conductor 130 and the second conductor 40, according to the first modified example in that the coil device 310 includes the multiple pairs of the first conductor 330 and the second conductor 340. However, as can be understood from comparison between FIGS. 10 and 13, the arrangement of one pair of the first conductor 330 and the second conductor 340 and the core 320 included in the coil device 310 viewed from the Y-axis direction is similar to the arrangement of the first conductor 130 and the second conductor 40 and the core 20 included in the coil device 110 viewed from the Y-axis direction.

That is, as shown in FIG. 13, in the first conductor 330, first connecting portions 333a, 333b are in a straight line to connect a first coil portion 331 and first mounting portions 332a, 332b straightly along a winding direction 62.

The first conductor 330 has a U-shaped external shape opening downward viewed from the Y-axis direction as a whole. One end surface and an other end surface of the first conductor face downward, and the respective end surfaces constitute first mounting surfaces of the first mounting portions 332a, 332b configured to face a mounting object.

The overall shape of the second conductor 340 is similar to that of the second conductor 40 included in the coil devices 10 and 110 according to the first embodiment and the first modified example. That is, the second conductor 340 includes a second coil portion 341 inside the core 320; second mounting portions 342a, 342b at least partly exposed from the core 320 and configured to face the mounting object; and two second connecting portions 343a, 343b connecting the second coil portion 341 and the second mounting portions 342a, 342b. The second coil portion 341 of the second conductor 340 extends along the winding direction 62 inward from the first coil portion 331 while adhering to the first coil portion 331 with an adhesive hardened portion 360 therebetween.

As shown in FIG. 13, in the coil device 310, upper ends of the inter-conductor spaces 350 start from the same height as that of connection locations 344 between the second coil portion 341 and the second connecting portions 343a, 343b. Downwardly from the connection locations 344, outer surfaces of the second connecting portions 343a, 343b become distant from the winding direction 62 (parallel to the Z-axis direction). Thus, the distance between the first conductor 330 and the second conductor 340 increases in a device center-side direction D21, below the connection locations 344.

A coupling controlling member 351 disposed in the inter-conductor spaces 350 includes a non-magnetic portion 351a containing a resin and a magnetic portion 351b containing a magnetic material. Characteristics of the coupling controlling member 351 are similar to those of the coupling controlling member 151 included in the coil device 110 according to the first modified example shown in FIG. 10.

All of the four pairs of the first conductor 330 and the second conductor 340 included in the coil device 310 have the common structure shown in FIG. 13. Similarly to the coil device 110 according to the first modified example, in the coil device 310, changing the sizes of the inter-conductor spaces 350 or the material or the constituent material content of the coupling controlling member 351 disposed in the inter-conductor spaces 350 can accurately control the coupling coefficient between the first conductor 330 and the second conductor 340 of such a coil device 310.

Because the one core 320 incorporates the multiple pairs of the first conductor 330 and the second conductor 340 in the coil device 310, for example, a mounting process for a circuit incorporating multiple (four) coil devices 110 according to the first modified example can be finished at once in the case of the coil device 310. This can improve manufacturing efficiency. Other than that, similarities between the coil device 310 and the coil devices 10 and 110 according to the first embodiment and the first modified example bring similar effects brought by the coil devices 10 and 110.

### Third Embodiment

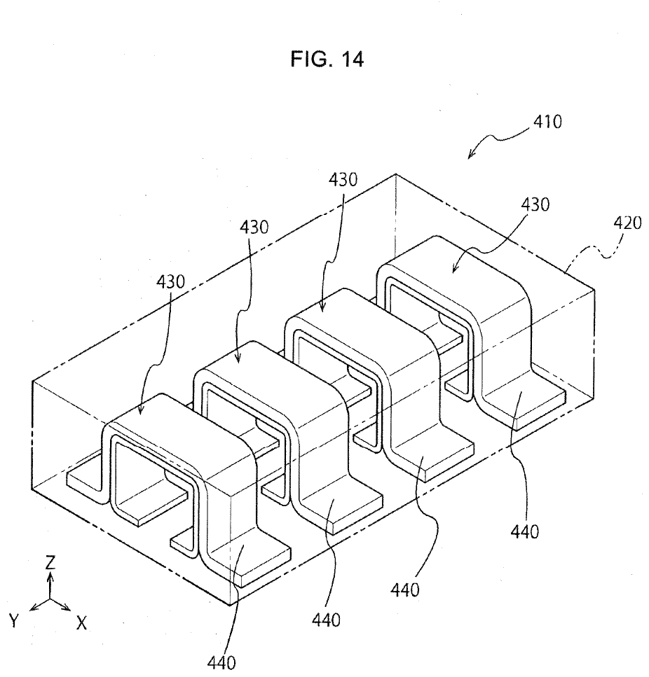

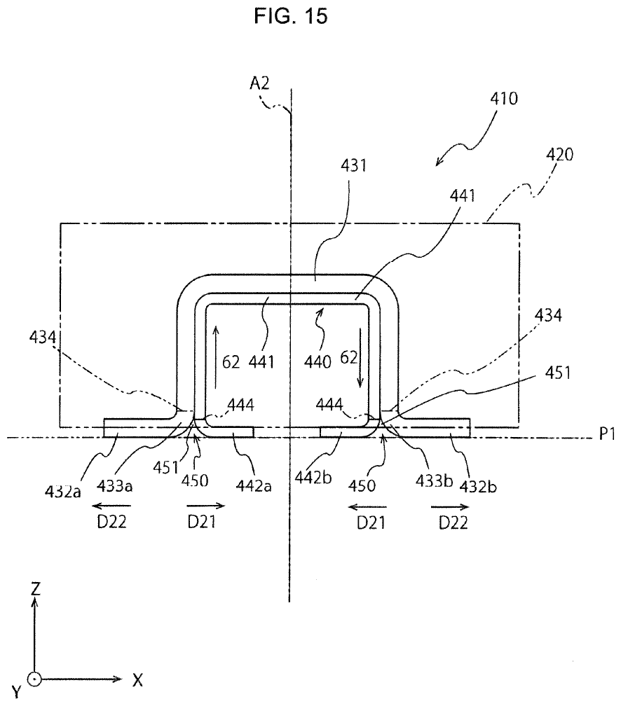

FIG. 14 is a schematic view of an overall structure of a coil device 410 according to a third embodiment. FIG. 15 is a schematic view of an arrangement relationship between a core 420 and inter-conductor spaces 450 of the coil device 410. Similarly to the coil device 310 according to the second embodiment, the coil device 410 according to the third embodiment includes, inside the one core 420, four pairs of a first conductor 430 and a second conductor 440 shown in FIG. 15. The pairs of the first conductor 430 and the second conductor 440 are arranged at substantially regular intervals along the Y-axis direction of the coil device 410.

As can be understood from comparison between FIG. 9 and FIGS. 14 and 15, the coil device 410 (see FIGS. 14 and 15) is different from the coil device 10 (see FIG. 9), which includes one pair of the first conductor 30 and the second conductor 40, according to the first embodiment in that the coil device 410 includes the multiple pairs of the first conductor 430 and the second conductor 440. The coil device 410 is different from the coil device 10 also in that a coupling controlling member 451 disposed in the inter-conductor spaces 450 does not include a non-magnetic portion and includes only a magnetic portion, unlike the inter-conductor spaces 50 and the coupling controlling member 51 included in the coil device 10 shown in FIG. 9. However, as can be understood from comparison between FIGS. 9 and 15, the overall shape of one pair of the first conductor 430 and the second conductor 440 and the core 420 included in the coil device 410 viewed from the Y-axis direction is similar to the overall shape of the first conductor 30 and the second conductor 40 and the core 20 included in the coil device 10 viewed from the Y-axis direction.

As shown in FIG. 15, the first conductor 430 has a rectangular wave shape protruding upward viewed from the Y-axis direction. Similarly to the first conductor 30 shown in FIG. 9, the first conductor 430 includes a first coil portion 431 inside the core 420; first mounting portions 432a, 432b at least partly exposed from the core 420 and configured to face a mounting object; and two first connecting portions 433a, 433b connecting the first coil portion 431 and the first mounting portions 432a, 432b.

Similarly, the second conductor 440 includes a second coil portion 441 inside the core 420; second mounting portions 442a, 442b at least partly exposed from the core 420 and configured to face the mounting object; and two second connecting portions 443a, 443b connecting the second coil portion 441 and the second mounting portions 442a, 442b. No adhesive hardened portion is disposed between the first conductor 430 and the second conductor 440. The second coil portion 441 of the second conductor 440 extends along a winding direction 62 inward from the first coil portion 431 while adhering to the first coil portion 431.

Similarly to the coil device 10 shown in FIG. 9, in the coil device 410, upper ends of the inter-conductor spaces 450 start from the same height as that of connection locations 434 between the first coil portion 431 and the first connecting portions 433a, 433b. Downwardly from the connection locations 434, inner surfaces of the first connecting portions 433a, 433b become distant from the winding direction 62 (parallel to the Z-axis direction). Thus, the distance between the first conductor 430 and the second conductor 440 increases in a device outward direction D22, below the connection locations 434. Further, outer surfaces of the second connecting portions 443a, 443b become distant from the winding direction 62 (parallel to the Z-axis direction) below connection locations 444 between the second coil portion 441 and the second connecting portions 443a, 443b. Thus, the distance between the first conductor 430 and the second conductor 440 increases also in a device center-side direction D21, below the connection locations 444.

The coupling controlling member 451 disposed in the inter-conductor spaces 450 includes the magnetic portion containing a magnetic material but does not include a non-magnetic portion not containing a magnetic material. The material and the like of the magnetic portion included in the coupling controlling member 451 are similar to those of the magnetic portion 51b included in the coupling controlling member 51 of the coil device 10 according to the first embodiment shown in FIG. 9.

All of the four pairs of the first conductor 430 and the second conductor 440 included in the coil device 410 have the common structure shown in FIG. 14. Similarly to the coil device 10 according to the first embodiment, in the coil device 410, changing the sizes of the inter-conductor spaces 450 or the material or the constituent material content of the coupling controlling member 451 disposed in the inter-conductor spaces 450 can accurately control the coupling coefficient between the first conductor 430 and the second conductor 440 of such a coil device 410. Other than that, similarities between the coil device 410 and the coil devices 10 and 310 according to the first embodiment and the second embodiment bring similar effects brought by the coil devices 10 and 310.

Hereinafter, more specific examples are provided for description of a coil device according to the present disclosure. However, characteristics of these examples are only some example characteristics of the coil device, and the examples are provided not with the intention of limiting characteristics of the coil device.

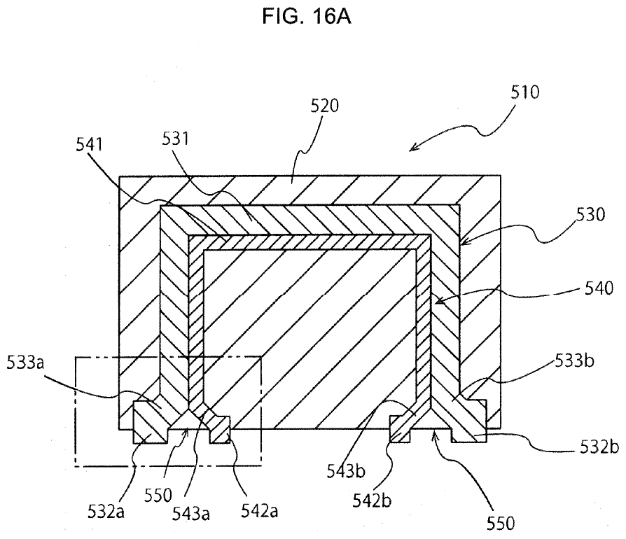

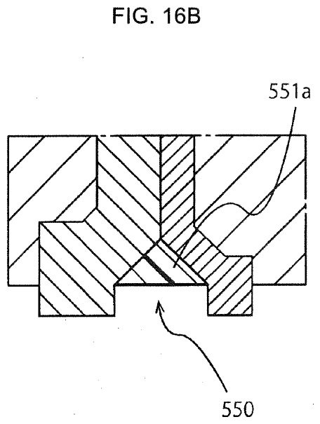

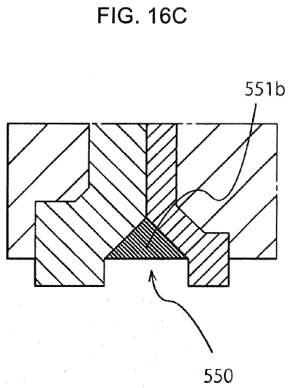

In the examples, simulation models of a coil device 510 shown in FIGS. 16A to 16C were created, and a material of a coupling controlling member disposed in inter-conductor spaces 550 was changed to confirm changes in the coupling coefficient between a first conductor 530 and a second conductor 540.

As shown in FIG. 16A, the coil device 510 included a core 520 containing a metal powder and a resin; the first conductor 530 including a first coil portion 531, first mounting portions 532a, 532b, and first connecting portions 533a, 533b; and the second conductor 540 including a second coil portion 541, second mounting portions 542a, 542b, and second connecting portions 543a, 543b.

In the coil device 510, the inter-conductor spaces 550, where the first connecting portions 533a, 533b and the second connecting portions 543a, 543b became distant from a winding direction to increase the distance between the first conductor 530 and the second conductor 540 toward a mounting object, were provided between the first conductor 530 and the second conductor 540.

In the examples, two samples were prepared, which were a sample 1 in which a coupling controlling member 551a including a non-magnetic portion constituted by a resin was disposed in the inter-conductor spaces 550 as shown in FIG. 16B and a sample 2 in which a coupling controlling member 551b including a magnetic portion constituted by a magnetic material was disposed in the inter-conductor spaces 550 as shown in FIG. 16C. The coupling controlling member 551a of the sample 1 had a relative permeability of 1. The coupling controlling member 551b of the sample 2 had a relative permeability of 35. The samples 1 and 2 were under the same conditions except for the coupling controlling members 551a, 551b disposed in the inter-conductor spaces 550.

The coupling coefficient (k factor) between the first conductor 530 and the second conductor 540 was calculated in the samples 1 and 2. The coupling coefficient in the sample 2 was 5% lower than that of the sample 1. These examples proved that changing the material of the coupling controlling members 551a, 551b disposed in the inter-conductor spaces 550 was able to control the coupling coefficient (k factor) between the first conductor 530 and the second conductor 540.

### REFERENCE NUMERALS

10, 110, 210, 310, 410, 510 . . . coil device
20, 320, 420, 520 . . . core
21 . . . core upper surface
22 . . . core lower surface
23 . . . first outer surface
24 . . . second outer surface
25 . . . third outer surface
26 . . . fourth outer surface
D21 . . . device center-side direction (toward device central axis)
D22 . . . device outward direction (away from device central axis)
A2 . . . device central axis
30, 130, 230, 330, 430, 530 . . . first conductor
31, 131, 231, 331, 431, 531 . . . first coil portion
31a, 131a. . . inner surface
62 . . . winding direction
32a, 32b, 132a, 132b, 232a, 232b, 332a, 332b, 432a, 432b, 532a, 532b . . . first mounting portion
32aa, 32ba . . . first mounting surface
32ab, 32bb . . . first mounting portion upper surface
33a, 33b, 133a, 133b, 233a, 233b, 333a, 333b, 433a, 433b, 533a, 533b . . . first connecting portion
40, 340, 440, 540 . . . second conductor
41, 341, 441, 541 . . . second coil portion
41b . . . outer surface
42a, 42b, 342a, 342b, 442a, 442b, 542a, 542b . . . second mounting portion
42aa, 42ba . . . second mounting surface
42ab, 42bb . . . second mounting portion upper surface
43a, 43b, 343a, 343b, 443a, 443b, 543a, 543b . . . second connecting portion
34, 44, 234, 344, 434, 444 . . . connection location
50, 150, 250, 350, 450, 550 . . . inter-conductor space
51, 151, 251, 351, 451, 551a, 551b . . . coupling controlling member
51a, 151a, 251a, 351a . . . non-magnetic portion
51b, 151b, 251b, 351b . . . magnetic portion
60, 360 . . . adhesive hardened portion
60a . . . end
P1 . . . mounting surface
L1, L2 . . . distance
G1 . . . gap

What is claimed is:

1. A coil device comprising:
a core comprising a metal powder and a resin;
a first conductor comprising
a first coil portion inside the core,
a first mounting portion at least partly exposed from the core and configured to face a mounting object on which the coil device is mountable, and
a first connecting portion connecting the first coil portion and the first mounting portion; and
a second conductor comprising
a second coil portion inside the core,
a second mounting portion at least partly exposed from the core and configured to face the mounting object, and
a second connecting portion connecting the second coil portion and the second mounting portion;
wherein
the second coil portion extends along a winding direction of the first coil portion inward from the first coil portion;
at least either the first connecting portion or the second connecting portion becomes distant from the winding direction to provide an inter-conductor space between the first conductor and the second conductor, the inter-conductor space having a distance increasing between the first conductor and the second conductor toward the mounting object; and
the inter-conductor space has a coupling controlling member disposed therein, the coupling controlling member comprising at least either a non-magnetic portion comprising a resin or a magnetic portion comprising a magnetic material.

2. The coil device according to claim 1, wherein the coupling controlling member has a resin content higher than that of the core.

3. The coil device according to claim 1, wherein the coupling controlling member comprises the magnetic portion comprising the magnetic material.

4. The coil device according to claim 3, wherein the magnetic material included in the magnetic portion is in a form of a metal powder; and
a content ratio of the metal powder included in the magnetic portion to a resin included therein is substantially the same as that of the core.

5. The coil device according to claim 3, wherein the magnetic portion has a higher permeability than that of the core.

6. The coil device according to claim 1, wherein
the first connecting portion is bent;
the first mounting portion connected to the first connecting portion extends away from a device central axis with respect to the first connecting portion leading to the first coil portion;
the second connecting portion is bent; and
the second mounting portion connected to the second connecting portion extends toward the device central axis with respect to the second connecting portion leading to the second coil portion.

7. The coil device according to claim 6, wherein the first mounting portion comprises a first mounting surface configured to face the mounting object;
the second mounting portion comprises a second mounting surface configured to face the mounting object; and
a connection location between the first connecting portion and the first coil portion is more distant from a plane containing the first mounting surface and the second mounting surface than a connection location between the second connecting portion and the second coil portion is.

8. The coil device according to claim 1, wherein the first connecting portion is in a straight line to straightly connect the first coil portion and the first mounting portion;
the second connecting portion is bent; and
the second mounting portion connected to the second connecting portion extends toward a device central axis with respect to the second connecting portion leading to the second coil portion.

9. The coil device according to claim 1, wherein the first coil portion has a sectional area larger than that of the second coil portion in a section orthogonal to the winding direction.

10. The coil device according to claim 1, wherein the first mounting portion comprises a first mounting surface and a first mounting portion upper surface, the first mounting surface being configured to face the mounting object, the first mounting portion upper surface being opposite the first mounting surface;
the second mounting portion comprises a second mounting surface and a second mounting portion upper surface, the second mounting surface being configured to face the mounting object, the second mounting portion upper surface being opposite the second mounting surface; and
at least either the first mounting portion upper surface or the second mounting portion upper surface is more distant from a plane containing the first mounting surface and the second mounting surface than a core lower surface of the core is.

11. The coil device according to claim 1, wherein the coupling controlling member is disposed inside the core.

12. The coil device according to claim 1, wherein
an inner surface of the first coil portion and an outer surface of the second coil portion are coupled to each other using an adhesive hardened portion comprising a hardened adhesive; and
the adhesive hardened portion extends along the winding direction and has an end leading to the coupling controlling member.
